(19) United States
(12) Patent Application Publication
(10) Pub. No.: US 2005/0187780 A1
(43) Pub. Date: Aug. 25, 2005

(54) Pre-commissioning service

(76) Inventors: Eric B. Ramsay, Kalamazoo, MI (US); Amparo Marles, Antioch, CA (US); Brent D. Murphy, Osceola, IN (US); Norman E. Lehto JR., St. Joseph, MI (US); John N. Kordomenos, LaGrange, IL (US)

Correspondence Address: Siemens Corporation;Attn: Elsa Keller, Legal Administrator, Intellectual Property Department, 170 Wood Avenue South, Iselin, NJ, 08830, US

(21) Appl. No.: 10/785,899

(22) Filed: Feb. 23, 2004

(51) Int. Cl. G06F 17/60

(52) U.S. Cl. 705/1

(57) ABSTRACT

A method may include selling a linear accelerator to emit treatment radiation to a buyer, commissioning the linear accelerator, and, after commissioning the linear accelerator, transmitting the linear accelerator to the buyer. Additional or alternative aspects may include buying a linear accelerator to emit treatment radiation and a service to commission the linear accelerator from a seller, and receiving the linear accelerator from the seller after the linear accelerator has been commissioned.

### BACKGROUND

1. Field

The present invention relates generally to the sale and/or purchase of linear accelerators used in radiation therapy.

2. Description

According to conventional radiation treatment, a beam of radiation is directed toward a tumor located within a patient. The radiation beam delivers a predetermined dose of radiation to the tumor according to an established treatment plan. The delivered radiation kills cells of the tumor by causing ionizations within the cells.

Treatment plans are therefore designed to maximize radiation delivered to a target while minimizing radiation delivered to healthy tissue. In order to achieve these goals, however, a treatment plan must accurately account for the expected characteristics of the specific radiation beam that will be used to deliver the radiation. These characteristics may include values such as intensity, flatness, symmetry and penumbra.

Commissioning refers to, among other things, a process for determining radiation beam characteristics. Particularly, a device for generating a radiation beam may be commissioned in order to determine characteristics of its particular radiation beam. The characteristics may then be used by a treatment planning system to design treatment plans that will be executed using the particular radiation beam.

A linear accelerator is one example of a device for generating and directing a radiation beam toward a patient. Conventionally, a buyer purchases a linear accelerator from a manufacturer and the linear accelerator is delivered to the buyer. Employees or contractors of the buyer then proceed to commission the linear accelerator in order to obtain characteristics, or beam data, of a radiation beam generated by the linear accelerator. The data may then be used to create a data book for commissioning a treatment planning system. The commissioning process often requires several weeks of work by one or more radiation oncology physicists. During this time, the linear accelerator cannot be used for treating patients.

It would therefore be beneficial to provide a system to reduce the loss of time and/or revenue due to commissioning after receipt of a linear accelerator by a buyer.

### SUMMARY

To address at least the above problems, some embodiments of the present invention provide a system, method, apparatus, and means to sell a linear accelerator to emit treatment radiation to a buyer, commission the linear accelerator, and, after commissioning the linear accelerator, transmit the linear accelerator to the buyer. In some embodiments, commissioning the linear accelerator may include modeling a treatment planning system based on the beam data.

Some aspects provide buying a linear accelerator to emit treatment radiation and a service to commission the linear accelerator from a seller and receipt of the linear accelerator from the seller after the linear accelerator has been commissioned. In further aspects, a data book or other medium including a modeled data set is received from the seller.

The claims are not limited to the disclosed embodiments, as those skilled in the art can readily adapt the teachings of the present application to create other embodiments.

### BRIEF DESCRIPTION OF THE DRAWINGS

FIG. 1 is a flow diagram of a process according to some embodiments.

FIG. 2 is a view of a test cell according to some embodiments.

FIG. 3 is a flow diagram of a process according to some embodiments.

FIG. 4 is a flow diagram of a process according to some embodiments.

FIG. 5 is a view of a linear accelerator in a radiation treatment room according to some embodiments.

FIG. 6 is a flow diagram of a process according to some embodiments.

### DETAILED DESCRIPTION

The following description is provided to enable any person skilled in the art to make and use the embodiments described herein and sets forth the best mode contemplated by the inventors. Various modifications, however, will remain readily apparent to those in the art.

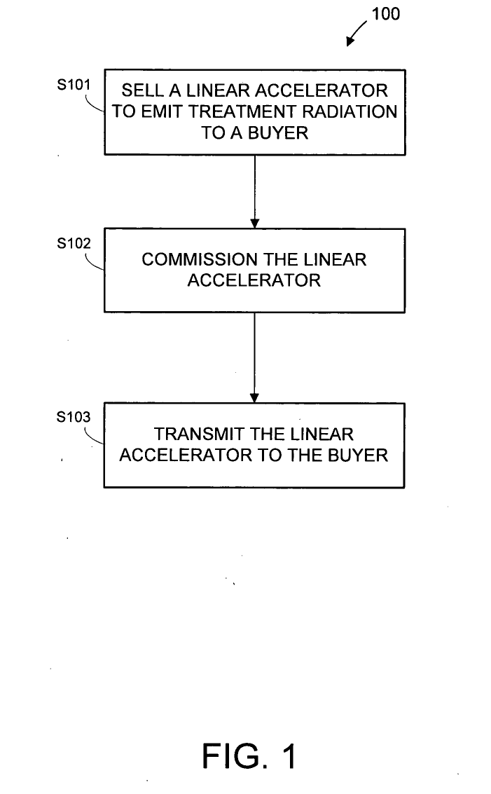

FIG. 1 is a flow diagram of process 100 according to some embodiments. Process 100 may be used to prepare a linear accelerator for use by a buyer. Process 100 may be executed by one or more individuals and/or business entities. In some embodiments, process 100 is executed by employees of a manufacturer of linear accelerators, such as employees of Siemens Corporation®. The steps of process 100 may be attributed to the manufacturer in such embodiments.

Initially, at step S101, a linear accelerator to emit treatment radiation is sold to a buyer. Details of a linear accelerator according to some embodiments will be discussed below. Step S101 may comprise entering into a binding contract to exchange a linear accelerator with a buyer for some manner of compensation. In this regard, the terms “sell”, “sale”, and “sold” are not necessarily used herein according to their common meaning of a full transfer of ownership. The linear accelerator may be “sold” to the buyer in step S101 under terms of a lease or any other type of contract in which possession of a good is transferred in exchange for some compensation.

The buyer may be any individual and/or entity. Non-exhaustive examples include hospitals, universities, dedicated research facilities, and private physicians groups. According to some embodiments of step S101, the buyer contacts the seller regarding an interest in a linear accelerator offered for sale by the seller. The sale may occur after several exchanges of technical information, negotiating positions, and business information. Other scenarios may precede the sale of step S101, including those in which communication between the buyer and seller is initiated by the seller.

The seller commissions the linear accelerator in step S102. The commissioning may comprise at least the determination of beam data associated with the linear accelerator. Step S102 may be performed by employees, contractors or other persons hired by the seller for this purpose. In some examples, the seller enters into a contract with a separate business entity to provide commissioning services to the seller. The commissioning may occur on premises of the seller and/or at one or more other locations.

Any currently- or hereafter-known system for commissioning a linear accelerator may be employed in step S102. Some details of a commissioning process according to some embodiments will be provided below.

Next, in step S103, the seller transmits the linear accelerator to the buyer. Any suitable currently- or hereafter-known system to transmit goods may be used in step S103. In one example, the seller contracts with a freight service to pick up the linear accelerator at its location after step S102 and to deliver it (e.g., by truck, rail and/or ship) to the buyer. The seller may alternatively arrange for shipment to a shipping point (e.g., a port) from where the buyer will pick up the linear accelerator according to known procedures. The seller may transmit different parts of the linear accelerator at different times according to some embodiments of step S103.

Some embodiments of process 100 reduce a delay between the sale of a linear accelerator and the use of the linear accelerator for radiation treatment.

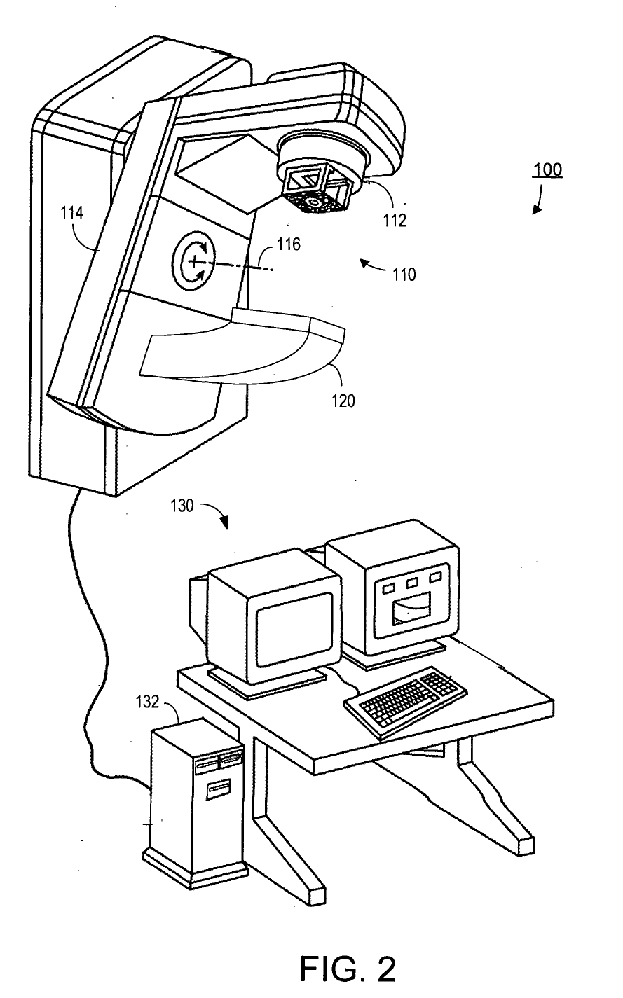

FIG. 2 illustrates test cell 100 pursuant to some embodiments. As shown, test cell 100 includes linear accelerator (linac) 110, imaging system 120, and operator station 130. Test cell 100 may comprise a location in which a recently-manufactured linear accelerator undergoes post-manufacturing testing. Linac 110 may comprise any linear accelerator configured to emit radiation. Examples of linac 110 according to some embodiments include the PRIMUS® and ONCOR® linear accelerators produced by Siemens Corporation®. Linac 110 includes a linear accelerator waveguide (not shown) used to produce a beam of electrons. The electrons may be directed to a target, thereby causing the emission of an X-ray radiation beam.

Treatment head 112 of linac 110 may include a beam-emitting device (not shown) for emitting the radiation beam during commissioning, testing, calibration, verification, and/or treatment. Although X-ray radiation is mentioned above, the radiation beam may comprise electron, photon or any other type of radiation. According to some embodiments, the treatment radiation comprises megavoltage radiation. Also included within treatment head 112 may be a beam-shielding device (not shown) for shaping the beam and for shielding sensitive surfaces from the beam.

Treatment head 112 is fastened to a projection of gantry 114. Gantry 114 is rotatable around gantry axis 116 in order to rotate treatment head 112 around axis 116.

In operation, treatment radiation is delivered from linac 110 treatment head 112 and is emitted therefrom as a divergent beam. The beam is emitted towards a point, known as the isocenter, which may be located at the intersection of an axis of the beam and gantry axis 116. Due to divergence of the radiation beam and the shaping of the beam by the aforementioned beam-shaping devices, the beam may deliver radiation to a multi-dimensional radiation field rather than only to the isocenter.

Imaging system 120 may be used to acquire images that may be used for commissioning, testing, calibration, verification, and/or treatment. For example, imaging system 120 may be used to acquire images of the aforementioned multi-dimensional radiation field. Such images may be used to acquire and/or confirm beam characteristics during the commissioning process. According to some embodiments, test cell 100 does not include imaging system 120.

Imaging system 120 may comprise any suitable type of imaging system. Imaging system 120 may comprise a flat-panel imaging device using a scintillator layer and solid-state amorphous silicon photodiodes deployed in a two-dimensional array. In some examples, imaging system 120 converts X-ray radiation to and stores X-ray radiation as electrical charge without use of a scintillator layer. In such imaging systems, X-rays are absorbed directly by an array of amorphous selenium photoconductors. The photoconductors convert the X-rays directly to stored electrical charge that comprises an acquired image of a radiation field. Imaging system 120 may also comprise a CCD or tube-based camera. Such an imaging device may include a light-proof housing within which are disposed a scintillator, a mirror, and a camera.

In some embodiments, test cell 100 includes a table for supporting phantoms, scanning systems with or without ion chambers, or other devices that may be used during testing and/or commissioning of linac 110. Such a table may be adjustable to assist in positioning devices such as the foregoing at the isocenter of linac 110.

A radiation oncology physicist may operate operator station 140 to commission linac 110 according to some embodiments. Operator station 140 may be located apart from linac 110, such as in a different room, in order to protect an operator from radiation emitted thereby. For example, linac 110 may be located in a heavily shielded room, such as a concrete vault, which shields an operator from the radiation emitted by linac 110.

Using operator station 130, the radiation oncology physicist may control linac 110 to emit a radiation beam according to desired parameters. Devices such as imaging system 120, phantoms, scanning systems with or without ion chambers, and other devices may then be used to acquire beam data associated with the radiation beam. The beam data may be stored in a storage medium of processor 132. Operator station 130 may be operated in test cell 100 to perform tasks other than commissioning, such as testing, calibration, and other tasks.

Although a single processor 132 is depicted in FIG. 2, those in the art will appreciate that the functions described herein may be accomplished using one or more computing devices operating together or independently. Any suitable general-purpose or specially-programmed computer may be used to achieve the functionality described herein.

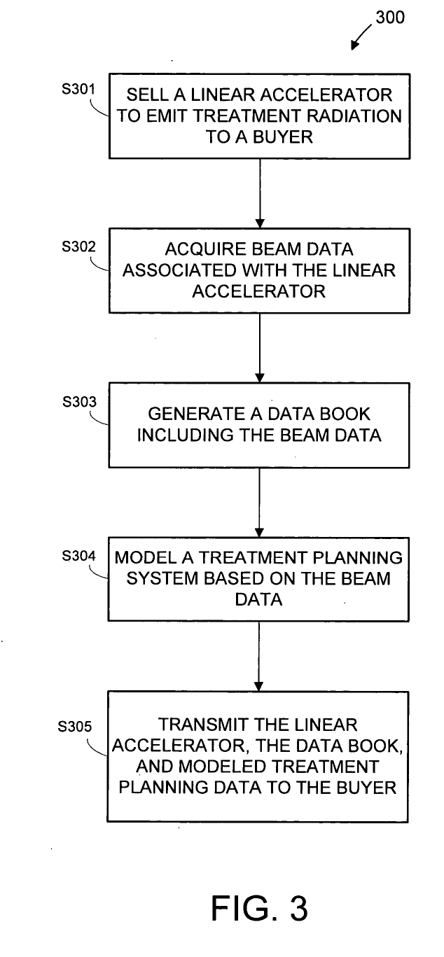

FIG. 3 is a diagram of process 300, which provides additional detail to some embodiments of process 100. Process 300 may be performed by any entity or entities described above with respect to process 100.

A linear accelerator to emit treatment radiation may be sold to a buyer in step S301 as described with respect to step S101. For purposes of the present example, it will be assumed that linac 110 of FIG. 2 is sold to the buyer in step S301. Moreover, it will be assumed that the seller is the manufacturer of linac 110. In some embodiments, the seller may be a reseller, a retailer, and/or a distributor of linac 110.

Next, in step S302, the seller acquires beam data associated with linac 110. The beam data may be acquired according to any currently- or hereafter-known systems for commissioning a linear accelerator. As known, beam data may include central axis dosage, scattered radiation values, wedge attenuation information, etc.

Some embodiments of step S302 comprise manual or automated operation of operator station 130 according to software executed by processor 132 to control linac 110 to emit various radiation beams. Devices such as those described above may then be operated to acquire beam data based on the emitted beams. In some embodiments, the devices, which may or may not include imaging system 120, are in communication with processor 132 and may be controlled thereby to acquire the beam data. According to such embodiments, the acquired beam data may then be stored within a storage medium of processor 132.

In some embodiments, the commissioning of process 300 is based on a treatment planning system associated with the buyer. Accordingly, the beam data may be generated based on the treatment planning system. For example, the buyer may identify a treatment planning system to the seller prior to step S302. A treatment planning system may be used to define and simulate a beam shape that is required to deliver an appropriate dose of radiation to a treatment area within a patient. A treatment planning system therefore requires information regarding a beam produced by a linear accelerator in order to accurately simulate a to-be-delivered radiation beam. Such information is known as the beam data associated with the linear accelerator.

As is known in the art, different treatment planning systems may require different beam data to simulate a radiation beam. For example, a treatment planning system may require data indicating a dose distribution within a first field size for specified energies at a first distance, while a second treatment planning system may require data indicating a dose distribution within a second field size for second specified energies at a second distance.

A data book including the beam data is generated in step S303. As is also known in the art, the data book may be provided in tabular and/or graphical form to comply with certain requirements and/or regulations governing the commissioning of a linear accelerator. The data book may be generated using known automated computer routines.

In step S304, a treatment planning system is modeled based on the beam data. Again, it is known in the art to model a treatment planning system based on beam data that is associated with a linear accelerator. Roughly, a modeled treatment planning system allows simulation of a radiation beam for which the treatment planning system does not have specific beam data.

In other words, the acquired beam data describes a small percentage of the possible treatment scenarios. A treatment planning system therefore uses algorithms to simulate a radiation beam that does not fit exactly within one of the scenarios described by the beam data. Modeling the treatment system comprises fine-tuning these algorithms to result in a match between simulated beam data and measured data in all treatment scenarios including those scenarios described by the beam data. Modeling the treatment planning system in step S304 may produce a data set that has been modeled for the treatment planning system.

The linear accelerator, the data book, and a modeled data set for the treatment planning system are transmitted to the buyer in step S305. Any suitable currently- or hereafter-known transmission system or systems may be used in step S305. One or more of the linear accelerator, the data book, and the modeled treatment planning system data may be transmitted to the buyer by different methods.

According to some embodiments, a modeled treatment planning system is generated in step S304. Therefore, the modeled treatment planning system may also or alternatively be transmitted to the buyer in step S305.

In some embodiments of process 300, other quality assurance steps are performed prior to step S305. These steps may include one or more of: completing a checklist for each step of the measurement and analysis process, comparing the generated beam data with beam data associated with other linear accelerators; double checking each measurement by a minimum of two qualified persons; graphically analyzing all measured data to assure accuracy of the data and to identify possible outlier data points; and final reviewing of the data book and the commissioning process by a senior medical physicist.

Flow proceeds directly from step S303 to step S305 according to some embodiments of process 300. Specifically, such embodiments do not comprise modeling of a treatment planning system by the seller. Such embodiments provide a buyer with an option to model the treatment planning system at its own facilities using a contractor and/or an employee of their choice. Accordingly, neither a modeled data set for a treatment planning system nor a modeled treatment planning system is transmitted to the buyer in step S305 of such embodiments. Rather, beam data formatted for a specified treatment planning system is transmitted to the buyer for use in modeling.

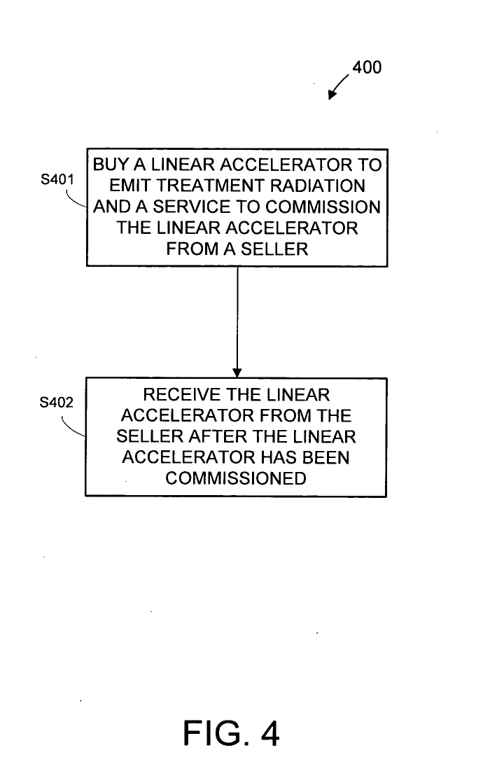

FIG. 4 is a flow diagram of process steps 400 performed by a buyer according to some embodiments. As mentioned above, a buyer may include a hospital, a university, a dedicated research facility, an individual, a private physicians group, and any other entity desiring a linear accelerator. Process 400 may, in some embodiments, decrease the time required between receipt of a linear accelerator and use of the linear accelerator to provide radiation treatment.

Initially, in step S401, the buyer buys a linear accelerator to emit treatment radiation and a service to commission the linear accelerator from a seller. “Buying” the linear accelerator as referred to herein may comprise entering into a lease or any other type of contract in which possession of the linear accelerator will be transferred to the buyer in exchange for some compensation. In some embodiments, the buyer's right to possess and/or use the linear accelerator may be subject to additional compensation and/or may expire over time.

According to some embodiments, the linear accelerator and the service may or may not be bought simultaneously. Either may be bought before the other, with any amount of time passing between the buying of the linear accelerator and the buying of the service. In one example, the buyer buys the linear accelerator, the linear accelerator is manufactured, and the buyer buys the service when the linear accelerator is in a test cell undergoing post-manufacturing testing.

The linear accelerator is received from the seller in step S402 after the linear accelerator has been commissioned. The linear accelerator may be received in any currently- or hereafter-known manner for receiving goods. The buyer may receive different parts of the linear accelerator at different times according to some embodiments of step S402.

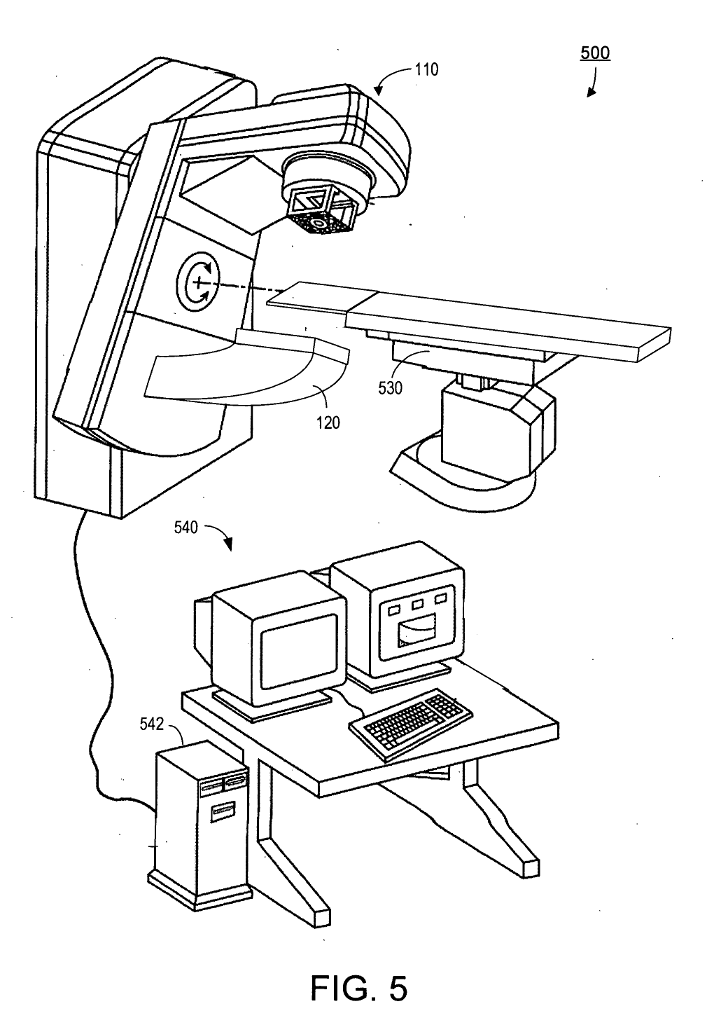

FIG. 5 is a view of radiation treatment room 500 of a buyer according to some embodiments. Room 500 may be located remotely from test cell 100. Room 500 includes linac 110 and imaging system 120, as it will be assumed that the buyer received linac 110 and imaging system 120 in step S402. Room 500 also includes table 530 and operator station 540. Radiation treatment room 500 may be used to provide radiation treatment to a patient according to some embodiments.

Table 530 may support devices such as phantoms, scanning systems with or without scanning ion chambers, positioning wedges or the like that may be used during commissioning verification, quality assurance, calibration, and/or radiation treatment. Table 530 may be adjustable to assist in positioning devices and/or a treatment area of a patient at the isocenter of linac 110.

An operator may operate operator station 540 to verify beam data of linac 110 according to some embodiments. Operator station 540 may also be used to deliver radiation according to a treatment plan. As such, operator station 540 may be located apart from linac 110 in order to shield an operator from radiation emitted thereby.

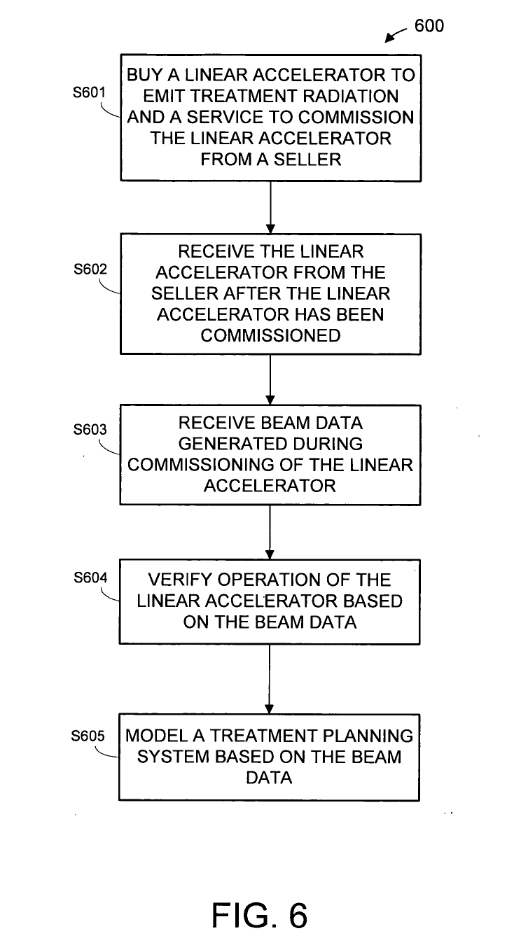

FIG. 6 is a flow diagram of process 600 to be executed by a buyer according to some embodiments. In this regard, the buyer buys a linear accelerator to emit treatment radiation and a service to commission the linear accelerator from a seller in step S601. Next, the linear accelerator is received from the seller in step S602 after the linear accelerator has been commissioned. Steps S601 and S602 may proceed as described above with respect to steps S401 and S402.

In step S603, the buyer receives beam data that was generated during the commissioning of the linear accelerator. The beam data may be received in electronic and/or hardcopy format (e.g., a data book) from the seller or from another party. Operation of the linear accelerator is then verified in step S604 based on the received beam data, which may include a specific set of data measured specifically for verifying linac performance. In some embodiments of step S604, operation is verified by recreating in treatment room 500 some or all of the linac configurations used to acquire the beam data in test cell 100 and comparing the resulting data with the received beam data.

Next, in step S605, a treatment planning system is modeled based on the received beam data as described with respect to step S304. Process 600 therefore reflects some embodiments in which the seller does not model the treatment planning system prior to transmitting the linear accelerator to the buyer. The modeling may be verified after step S605.

In a case that the seller modeled the treatment planning system as in process 300, step S605 may be substituted with a step in which the modeling is verified. The modeling may be verified using known techniques. These techniques may include determining expected beam characteristics in a particular treatment scenario using the treatment planning system, and then comparing the expected beam characteristics against actual beam characteristics acquired in treatment room 500 under the scenario.

Those in the art will appreciate that various adaptations and modifications of the above-described embodiments can be configured without departing from the scope and spirit of the claimed invention. Also, embodiments of the claimed invention may differ from the descriptions above.

1. A method comprising:
selling a linear accelerator to emit treatment radiation to a buyer;
commissioning the linear accelerator; and
after commissioning the linear accelerator, transmitting the linear accelerator to the buyer.

2. A method according to claim 1, wherein the commissioning is based on a treatment planning system associated with the buyer.

3. A method according to claim 1, wherein commissioning the linear accelerator comprises:
acquiring beam data associated with the linear accelerator.

4. A method according to claim 3, further comprising:
transmitting a data book including the beam data to the buyer.

5. A method according to claim 3, wherein commissioning the linear accelerator further comprises:
modeling a treatment planning system based on the beam data.

6. A method according to claim 1, further comprising:
manufacturing the linear accelerator.

7. A method according to claim 1, wherein the commissioning is conducted in a post-manufacturing test cell.

8. A method according to claim 1, wherein the buyer is located at a remote location.

9. A method comprising:
buying a linear accelerator to emit treatment radiation and a service to commission the linear accelerator from a seller; and
receiving the linear accelerator from the seller after the linear accelerator has been commissioned.

10. A method according to claim 9, wherein the service to commission comprises a service to commission based on a treatment planning system associated with the buyer.

11. A method according to claim 9, further comprising:
receiving beam data acquired during the commissioning of the linear accelerator from the seller.

12. A method according to claim 11, further comprising:
verifying operation of the linear accelerator based on the beam data after receiving the linear accelerator from the seller.

13. A method according to claim 12, further comprising:
modeling a treatment planning system based on the beam data after receiving the linear accelerator from the seller.

14. A method according to claim 11, further comprising receiving a data book containing the beam data from the seller.

15. A method according to claim 11, further comprising:
receiving from the seller a modeled data set for a treatment planning system or a modeled treatment planning system based on the beam data.

16. A method according to claim 15, further comprising:
acquiring second beam data using the linear accelerator; and
verifying that calculations performed by the modeled treatment planning system are consistent with the second beam data.

17. A method according to claim 9, wherein the seller is a manufacturer of the linear accelerator.

18. A method according to claim 9, wherein the commissioning is conducted in a post-manufacturing test cell.

19. A method according to claim 9, wherein the seller is located at a remote location.
